(19) United States
(12) Patent Application Publication
(10) Pub. No.: US 2013/0040151 A1
(43) Pub. Date: Feb. 14, 2013

(54) METHOD FOR JOINING FIBRE-CONTAINING COMPOSITE MATERIALS

(71) Applicants: Premkumar Jeromerajan, Singapore (SG); Srikanth Narasimalu, Singapore (SG); Erwin Merijn Wouterson, Singapore (SG); Wojciech Stanislaw Gutowski, Frankston (AU); Sheng Li, Glen Waverley (AU); Weidong Yang, Glen Waverley (AU)

(72) Inventors: Premkumar Jeromerajan, Singapore (SG); Srikanth Narasimalu, Singapore (SG); Erwin Merijn Wouterson, Singapore (SG); Wojciech Stanislaw Gutowski, Frankston (AU); Sheng Li, Glen Waverley (AU); Weidong Yang, Glen Waverley (AU)

(73) Assignee: VESTAS WIND SYSTEMS A/S, Aarhus (DK)

(21) Appl. No.: 13/516,609

(22) PCT Filed: Dec. 16, 2010
(86) PCT No.: PCT/EP2010/069921

§ 371 Date: Oct. 29, 2012

(30) Foreign Application Priority Data
Dec. 16, 2009 (DK) PA 2009 70277
Dec. 16, 2009 (US) 61284315

(51) Int. Cl. B32B 38/08; B32B 27/42; F03D 11/00; B32B 9/04; B32B 37/12; B32B 37/06

(52) U.S. Cl. 428/447; 156/60; 156/82; 156/272.6; 156/273.3; 156/330; 156/331.7; 156/390; 416/230; 428/524

(57) ABSTRACT

The present invention relates to methods for joining and for improving interfacial strength of joints in objects of fibre-containing composite materials, such as epoxy/glass fibre composite materials of a wind turbine blade, as well as fibre reinforced composite materials, laminates and other interconnected objects prepared by this method. In particular wind turbine blades prepared by this method are described. The present invention further relates to robots and robotic tools for carrying out the described methods for joining objects of fibre-containing composite materials.

### FIELD OF THE INVENTION

The present invention relates to methods for joining and for improving interfacial strength of joints in objects of fibre-containing composite materials, such as epoxy/glass fibre composite materials of a wind turbine blade, as well as fibre reinforced composite materials, laminates and other interconnected objects prepared by this method. In particular wind turbine blades prepared by this method are described. The present invention further relates to robots and robotic tools for carrying out the described methods for joining objects of fibre-containing composite materials.

### BACKGROUND OF THE INVENTION

Advanced composite materials are widely utilized in the industry due to their high strength, low weight, high degree of stiffness, and stability against dimensional variation. The right composite materials are very durable and also very resistant to heat and corrosion, which makes them ideal for use in products that are exposed to extreme environments such as boats, chemical-handling equipment, and alternative energy mechanisms such as wind turbines.

Modern wind turbines comprise a plurality of wind turbine rotor blades, typically three blades, each blade having a weight of up to 15 tons and a length of up to 55 meters.

Traditionally, a blade comprises two shell parts, one defining a windward side shell part and the other one defining a leeward side shell part. Each of the shell parts are traditionally made in one piece. To reinforce such a blade, a beam- or box-shaped, longitudinal and tubular element, i.e. a spar, can act as a reinforcing beam running lengthways, i.e. in the longitudinal direction of the blade. The spar is located in the cavity between the two wind turbine shell parts and extends substantially throughout the shell cavity in order to increase the strength and stiffness of the wind turbine blade. A blade may further be reinforced by two or more spars placed lengthways side by side.

There is often a need to join or to connect different part of composite materials, such as different parts within the wind turbine blade, preferably using an adhesive to provide the highest strength joint. One of the difficulties, however, is joining these composites together to form variously shaped structures. In particular, wind turbine manufactures applications demand adhesion and bonding that can withstand the centrifugal forces applied to each blade. They must at the same time bond very large components, such as the two shell part of a blade envelope and the spar. They must then maintain bond strength for the blade's lifetime under constant thermal cycling and environmental attack.

One of the methods employed in joining composite parts is the application of an adhesive in combination with a peel ply, which give the composite part a rough and increased surface area for better contact between the different parts of composite materials prior to application of the adhesive. Alternatively the surface may be activated by sand blasting, which method has environmental and hazardous issues. Surface activation for improving of adhesive bonding have been discussed in general in U.S. Pat. Nos. 5,872,190, 5,879,757, 5,922,161, 6,800,331, 6,830,784.

Not only must the method for joining provide durable bonding, it must also be easily processed so that it can be used in a variety of conditions in the field.

There is a need for even better methods for joining that meet all the requirements of adhesive strength, durability, working time, and processability necessary for the bonding of composite parts of wind turbines, for example.

### OBJECT OF THE INVENTION

It is an object of embodiments of the invention to provide methods for joining fibre-containing composite materials, wherein the joints formed have increased and more uniform adhesive strength, and/or increased durability (fatigue life) and/or improved interfacial toughness, and/or negligible or no weight increase.

It is a further object of the present invention to provide methods for joining fibre-containing composite materials, wherein the method employed are more optimal with respect to at least one of less processing time, increased worker safety, less environmental pollution, higher processability, less costs, less impurity, and/or with fast, reliable robotic means.

### SUMMARY OF THE INVENTION

It has been found by the present inventor(s) that a more optimal joining of fibre-containing composite materials is achieved by coating one or both surfaces of the composite material with an anchoring molecule as described herein prior to applying an adhesive. Preferably the coating with anchoring a molecule is combined with a step of oxidising one or both surfaces prior to coating with anchoring molecules.

So, in a first broad aspect the present invention relates to a method for preparing a joint of a first fibre-containing composite material and a second fibre-containing composite material the method comprising the steps of:
a) coating said surfaces of said first and second fibre-containing composite material with at least one anchoring agent selected from an organo silane or an amine;
b) applying an adhesive to said surfaces; and
c) combining said first and second fibre-containing composite material in a joint.

In another aspect the present invention relates to method for preparing a joint of a first fibre-containing composite material and a second fibre-containing composite material the method comprising the sequential steps of:
a) oxidizing the surfaces of said first and second fibre-containing composite material in order to etch the surface and/or to increase the amount of functional groups, such as hydroxyl groups on said surfaces;
b) coating said surfaces of said first and second fibre-containing composite material with at least one anchoring agent selected from an organo silane or an amine;
c) applying an adhesive to said surfaces; and
d) combining said first and second fibre-containing composite material in a joint.

In another aspect the present invention relates to a fibre reinforced composite material comprising a joint prepared by a method according to the invention.

In another aspect the present invention relates to a laminate or interconnected object of fibre reinforced composite material produced by a method according to the invention.

In another aspect the present invention relates to a wind turbine blade made by a process according to the invention, or made of a laminate or interconnected objects according to the invention.

In another aspect the present invention relates to a wind turbine comprising one or more wind turbine blades according to the invention.

In another aspect the present invention relates to a method for improving interfacial strength of a joint of two objects made of fibre-containing composite material, said method comprising the steps of:
a) coating said surfaces of said first and second fibre-containing composite material with at least one anchoring agent selected from an organo silane or an amine;
b) applying an adhesive to said surfaces; and
c) combining said first and second fibre-containing composite material in a joint.

In another aspect the present invention relates to a method for improving interfacial strength of a joint of two objects made of fibre-containing composite material, said method comprising the sequential steps of:
a) oxidizing the surfaces of said first and second fibre-containing composite material in order to etch the surface and/or to increase the amount of functional groups, such as hydroxyl groups on said surfaces;
b) coating said surfaces of said first and second fibre-containing composite material with at least one anchoring agent selected from an organo silane or an amine;
c) applying an adhesive to said surfaces; and
d) combining said first and second fibre-containing composite material in a joint.

In another aspect the present invention relates to a robot suitable for carrying the method according to the invention. In particular, the robot may be fitted with a robot tool with combined process means such that the same tool can be used at least both for the oxidation and the application of the anchoring chemical composition, and optionally also for application of glue for the adhesive bonding of the two fibre-containing composite materials.

The robot tool may e.g. comprise a combination of a flame nozzle and a spray nozzle such that the same tool can be used for flame treatment and for application of a chemical composition by spraying, in addition, the tool may comprise an extrusion head for extruding glue onto the surface of one or both of the two composite materials.

A tool base coordinate frame may be defined for the tool, and one process coordinate frame could be defined for each process nozzle of the tool in such a manner that the correct distance and orientation of the tool relative to the workpiece, in this case one of the two composite materials, is described relative to the tool base coordinate frame. In particular, the tool may be reconfigurable such that at least two of process coordinate frames can be positioned identical relative to the tool base coordinate frame. In this way, the individual processes, i.e. the oxidation, the application of the anchoring agent, and optionally also the application of glue can be done with one and the same robot program.

In another aspect the present invention relates to the use of a chemical composition comprising an organo silane or an amine, for establishing anchoring for an adhesive on a fibre-containing material.

In another aspect the present invention relates to the use of a chemical composition comprising organo silane selected from the group consisting of an organo silane having 1 to 3 readily hydrolyzable groups and containing at least one organic group attached directly to the silicon atom, the corresponding silanes, silanols and/or polysiloxanes, for establishing anchoring for an adhesive on a fibre-containing material.

In another aspect the present invention relates to a tool for a robot, the tool including a first tool side pointing in a forward direction and a second tool side pointing in an opposite rearward direction, the first tool side comprising at least one spray nozzle in fluid communication with a high pressure spray system for spraying an anchoring agent, and the second tool side comprising a nozzle for establishing an O2 enriched flame.

### LEGENDS TO THE FIGURE

FIG. 1 is a schematic view of the surface activation technology (SAT) for Wind Turbine blades. GRP: Glass Reinforce Plastics; SAT: Surface Activation Technology.

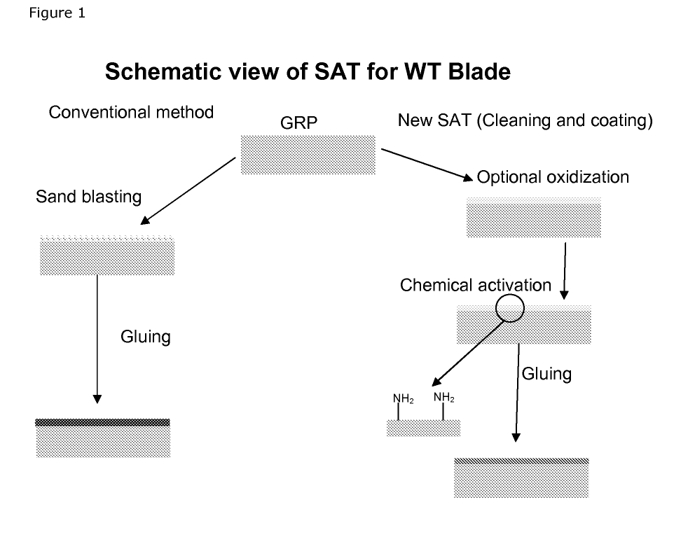

FIG. 2: Automation of SAT by ROBOT; A: Robot with twin nozzle, B: expanded view of circled area from A.

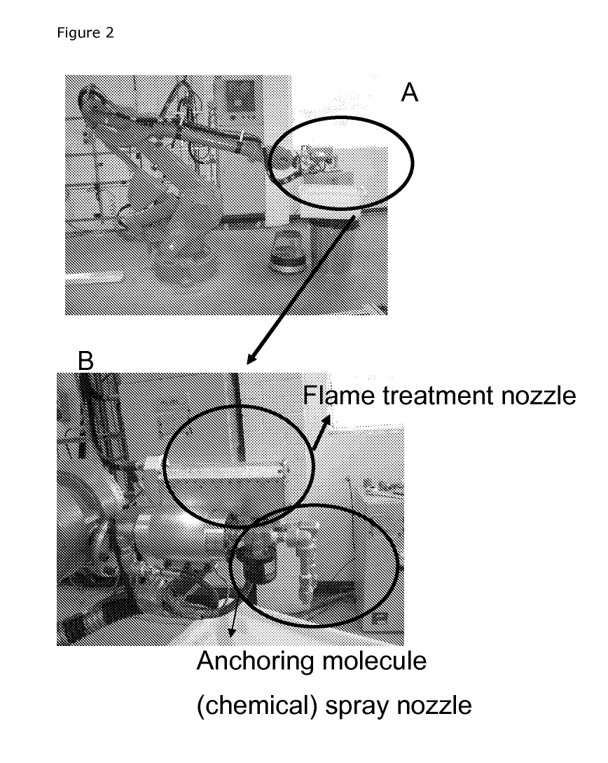

FIG. 3: Sequential details of the procedure of preparation of lap-shear test assemblies: (a) mixing, (b)-(d) gluing, (e)-(g) clamping, (h) After curing.

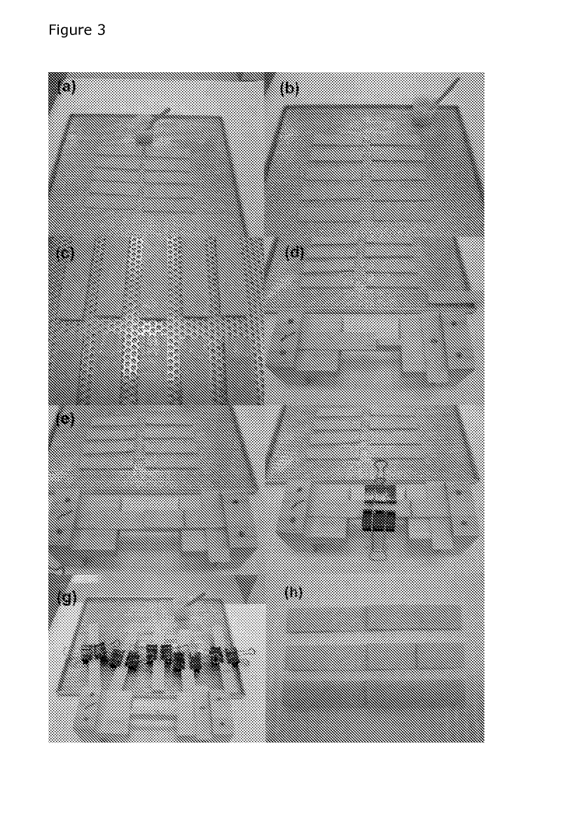

FIG. 4: Analysis of SAT results. No SAT resulted in adhesive (interface) failure, SAT resulted in cohesive failure. No SAT resulted in shear strength of 8.48+/−1 MPa with adhesive (interface) failure; SAT resulted in shear strength: 14-18+/−1 MPa with cohesive failure.

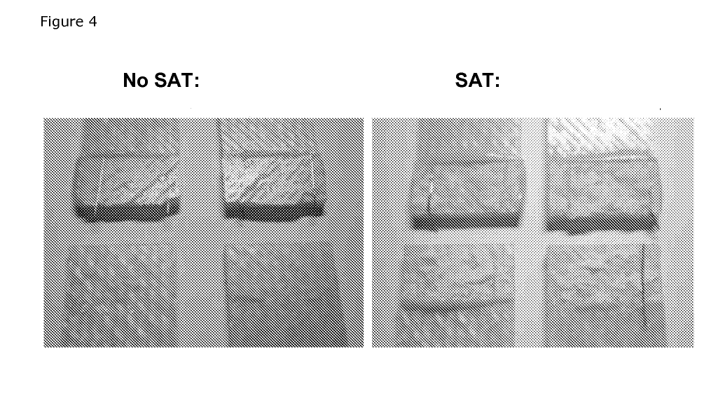

### DETAILED DISCLOSURE OF THE INVENTION

As described previously the present invention relates to methods preparing a joint of a first fibre-containing composite material and a second fibre-containing composite material the method comprising the sequential steps of:
a) oxidizing the surfaces of said first and second fibre-containing composite material in order to etch the surface and/or to increase the amount of functional groups, such as hydroxyl groups on said surfaces;
b) coating said surfaces of said first and second fibre-containing composite material with at least one anchoring agent selected from an organo silane or an amine;
c) applying an adhesive to said surfaces; and
d) combining said first and second fibre-containing composite material in a joint.

The fibres of the fibre-containing composite material may be selected from the group consisting of carbon fibres, polymer fibres, glass fibres, aramid fibres, synthetic fibres, bio fibres, mineral fibres, ceramic fibre metal fibres, boron fibres, and combinations of these.

In some embodiments, the fibrous material includes or consists of glass fibre. Suitable examples of glass fibres may include E-glass or S-glass fibre. In one embodiment, a fibrous material may include a polymer fibre. Suitable examples of fibres may include, but are not limited to, glass fibres (for example, quartz, E-glass, S-2 glass, R-glass from suppliers such as PPG, AGY, St. Gobain, Owens-Corning, or Johns Manville), polyester fibres, polyamide fibres (for example, NYLON polyamide available from E.I. DuPont, Wilmington, Del., USA), aromatic polyamide fibres (such as KEVLAR aromatic polyamide available from E.I. DuPont, Wilmington, Del., USA; or P84® aromatic polyamide available from Lenzing Aktiengesellschaft, Austria), polyimide fibres (for example, KAPTON polyimide available from E.I. DuPont, Wilmington, Del., USA), or extended chain polyethylene (for example, SPECTRA polyethylene from Honeywell International Inc., Morristown, N.J., USA; or DYNEEMA polyethylene from Toyobo Co., Ltd.), and the like.

In some embodiment, the fibrous material may include a carbon fibre. Suitable examples of carbon fibres may include, but are not limited to, AS2C, AS4, AS4C, AS4D, AS7, IM6, IM7, IM9, and PV42/850 from Hexcel Corporation; TORAYCA T300, T300J, T400H, T600S, T700S, T700G, T800H, T800S, T1000G, M35J, M40J, M46J, M50J, M55J, M60J, M305, M30G, and M40 from Toray Industries, Inc; HTS12 K/24K, G30-500 3 K/6 K/12 K, G30-500 12 K, G30-700 12 K, G30-700 24K F402, G40-800 24K, STS 24K, HTR 40 F22 24K 1550tex from Toho Tenax, Inc; 34-700, 34-700WD, 34-600, 34-600WD, 34-600 Unsized from Grath inc.; T-300, T-650/35, T-300C, T-650/35C from Cytec Industries.

A particular suitable fibre is glass fibres. Any suitable glass fibre may be used in the method according to the present invention. The term “glass fibres” as used herein means fibres formed by attenuation of one or more streams of molten glass and to strands formed when such glass fibre filaments are gathered together in the forming. The term includes yarns and cords formed by plying and/or twisting a multiplicity of strands together and to woven and non-woven fabrics which are formed of such glass fibre strands, yarns, cords, films or wafers, or may be particulate glass which is used as filler or a catalytic substrate in a number of applications. The invention is particularly applicable to continuous drawn fibreglass fibres (bundles) which are used as reinforcing fibres in the manufacture of polymer bound composites. The present invention is usable with E-type as well as S-type glass-fibres.

The resin of the fibre-containing composite material may be based on unsaturated polyester, polyurethane, polyvinylester, epoxy, thermoplastics, or combinations of these.

The resins employed in the practice of this invention are commercially available in solutions which can be simply blended with other components in the preparation of the compositions embodying the features of the present invention. Suitable glass includes silica, alumina, silicate and other oxide glasses.

The methods according to the present invention utilize at least one glass fibre anchoring agent, such as in the form of an organo silicon compound or an amine, such as a secondary amine. Preferred for this purpose are functional silane monomers or polymers containing a functional group which can couple with the resinous fibre binder materials. Suitable functional silanes include amino silanes, vinyl silanes, methacryloxy silanes, mercaptosilanes, and epoxy silanes.

Preferred for this purpose are organo silicon compounds which include organo silanes containing one to three hydrolyzable groups, such as halogen (bromine, chlorine, fluorine or iodine) or alkoxy having one to six carbon atoms, such as methoxy, ethoxy, propoxy, butoxy, etc., and containing at least one organic group attached directly to the silicon atom, with any remaining valences on the silicon atom being taken up by hydrogen. Under mild acidic conditions in aqueous solution according to the present invention, such silanes hydrolyze to form the corresponding silanols and/or siloxanes, and hence the anchoring agent is present in the aqueous size composition of the invention as the silane, silanol and/or siloxane.

The organic group or groups attached at the silicon atom may a variety of groups including alkyl having 1-10 carbon atoms, such as methyl, ethyl propyl, hexyl, etc.; alkenyl containing 2-8 carbon atoms, such as vinyl, alkyl, etc.; cycloalkyl having 4-8 carbon atoms, such as cyclopentyl, cyclohexyl, etc.; aryl containing 6-15 carbon atoms, such as phenyl, naphthyl, benzyl, etc. and the halogen, amino, hydroxy, mercapto, glycidoxy or epoxy substituted derivatives thereof. It is to be understood that wherein organo silane contains more than one organic group, the various organic groups attached to the silicon atom can be the same or different from each other.

Representative examples of compounds falling within the above group are ethyldichlorosilane, propyltrichlorosilane, n-butyl-trimethoxysilane, gamma-aminopropyltrimethoxysilane, delta-aminobutyltriethoxysilane, bis(gamma-aminopropyl)di-methoxysilane, delta-aminobutylethyldimethoxysilane, beta-hydroxyethyltriethoxysilane, glycidoxypropyltrimethoxysilane, gamma-chloropropyl-trichlorosilane, vinyldichlorosilane, gamma-aminoallytrimethoxysilane, beta-amino-vinyltriethoxysilane, 3,4-epoxycyclohexyltrimethoxysilane, 3-amino-cyclohexylethyltriethoxysilane, paraminophenyltriethoxysilane, methacryloxypropyltri-methoxysilane, N-(be a-aminoethyl)-gamma-aminopropyltri-methoxysilane, gamma-mercapropropyltriethoxysilane, gamma-hydropropyltrimethoxysilane, as well as a variety of others. In general, those silanes preferred are those in which at least one group is substituted by at least one amino group.

Examples of such functional silane monomers and polymers thereof, include gamma-aminopropyltrialkoxysilanes, gamma-isocyanatopropyl-triethoxysilane, vinyl-trialkoxysilanes, glycidoxypropyltrialkoxysilanes and ureidopropyltrialkoxysilanes, such as A-187 gamma-glycidoxy-propyltrimethoxysilanes, A-174 gamma-methacryloxypropyltrimethoxysilane, A-1100 gamma-aminopropyl-triethoxysilane, A-1108 amino silane and A-1160 gamma-ureidopropyl-triethoxysilane (each of which are commercially available from OSi Specialties, Inc. of Tarrytown, N.Y.).

Amino silane, monomers and polymers have been found to be particularly effective, e.g. trimethoxysilylpropyldiethylene-triamine, N-methylaminopropyltrimethoxysilane, aminoethylaminopropylmethyldimethoxysilane, aminoethylaminopropyltrimethoxysilane (Dow Corning Z-6020), a homopolymer of an amino silane (Dow Corning Z-6137), aminopropylmethyldimethoxysilane, aminopropyltrimethoxysilane, polymeric aminoalkylsilicone, aminoethylaminoethylaminopropyl-trimethoxysilane, N-methylaminopropyltrimethoxysilane, methylamino-propyltrimethoxysilane, aminopropylmethyldimethoxysilane, aminopropyltriethoxysilane, 4-aminobutyltriethoxysilane, and oligomeric aminoalkylsilane and the like, which are available from Dow Corning, Midland, Mich., Union Carbide Specialty Chemicals Division, Danbury Conn. and Huls of America, Piscataway, N.J., Wacker Silicones Corporation of Adrian, Mich.

Particularly preferred organo silanes used according to the present invention are (3-aminopropyl)trimethoxysilane, N-(2-aminoethyl)-3-amino-propyltrimethoxy silane (Z-6020, Dow Corning), as well as (3-((2-Aminoethyl)amino)propyl) silanetriol homopolymer (Z-6137, Dow Corning).

An alternative to organo silanes as suitable anchoring agent are amines, such as polyamines, such as secondary polyamines, and in particular a polyethylene imine having an average molecular weight from 200 to 200,000 Daltons. In some embodiments a linear polyethylene imine is used, but it may also be partially branched.

Preferably the anchoring agents, such as an organo-silane, are used in the method according to the present invention in aqueous solutions in an amount of 0.1 to 0.15% of the anchoring agent.

However, the anchoring agents, such as an organo-silane may be used in the method according to the present invention in aqueous solutions in an amount of 0.1% to 0.5% of the organo-silane, such as in an amount 0.1% to 0.4%, such as in an amount 0.1% to 0.3%, such as in an amount 0.1% to 0.2%, such as in an amount 0.1% to 0.15%.

In some embodiments according to the invention, the fibre reinforced surface will be treated prior to the coating with anchoring agents, such as an organo-silane or an amine. This may include a gentle cleaning as well as chemical and physical treatments, such as oxidizing methods like plasma, corona discharge, and flame activation. When using the above oxidation techniques, the high energy will oxidise the top surface of the composite material and convert chemical groups in the composite material into oxygenated functional groups, such as hydroxyl, carboxyl, and/or carbonyl functional group.

The fibre reinforced polymer surface used according to the present invention may be treated with a plasma treatment, such as when subjecting the fibre surface to ionized gas plasma containing water vapour under conditions such that the water molecules become highly excited, ionized and disassociated. In this condition, the water quickly hydrates the glass surface which it contacts leading to increased hydroxyl group density on the glass surface.

The binding strength obtained by the methods according to the present invention may be higher than e.g. 10 MPa, such as higher than 15 MPa, such as higher than 20 MPa between the two composite materials while using the surface activation. Binding strength means interlocking between the adhesives and the composite panels in terms of physical and mechanical bonding. The strength can be measured by single lap shear tests using universal tensile test equipment.

The resin for the composite material may be provided as liquid, semisolid or solid resin. The resin may be a thermoplastic or a thermosetting resin. The resin may be based on unsaturated polyester, polyurethane, polyvinylester, epoxy, thermoplastics or similar chemical compounds, including combinations of these. In some embodiments of the invention, the resin used in the composite materials according to the present invention is provided as a liquid and the resin has been introduced by Resin Infusion, Resin Transfer Moulding, RTM, RFI (Resin film Infusion), or Vacuum Assisted Resin Transfer Moulding, VARTM, into an entity comprising several layers comprising fibres (e.g. fibre tows or any other suitable collection comprising fibres mentioned herein).

The adhesive used according to the present invention may be any tacky material, or a solid with a tacky surface and the adhesive may for example comprise polyester, polyurethane, polyvinylester, epoxy or similar compounds or a combination of these. It is within the scope of the invention to use any material or combination of materials having a tacky surface including solid materials with tacky surfaces. More than one type of adhesive may be used in one member or in the interface of composite joints. For example, it is within the scope of the invention to use the resin as an adhesive between layers of fibre tows, where a resin is provided, or to use a second type of resin below the first layer of fibre tows. A preferred adhesives used according to the present invention is polyurethane.

In some preferred embodiments, the resin is a solid resin. An entity comprising several layers of oriented fibre tows, which may have been immobilised during fibre laying by an adhesive, and a solid resin system is heated under vacuum in order to prepare a pre-consolidated or cured pre-form.

In a further preferred embodiment, the resin is a semisolid and functions both as resin and as adhesive, i.e. during fibre laying, the resin will immobilise the fibres and during subsequent processing, it functions as a matrix material.

The resin may comprise more than one system. It may be advantageous to use more than one resin system to be able to optimise the properties of the resin for the subsequent steps of processing, for example with respect to viscosity and timing/controlling of the curing process. These systems may or may not be based on the same type of resin, however, it is preferred that such systems are based on the same type of resin such as two or more epoxy-based systems. In another preferred embodiment, the resin types differ but the resins are compatible. In a further preferred embodiment, the resin comprises two substantially epoxy-based systems. The two epoxy-based systems may comprise a common component. The common component may for example be a common catalyst, a common amine component or a common epoxy component, however, it is preferred that the common component is an epoxy component. A resin comprising two epoxy-based systems with a common epoxy component may comprise an amine-component of a first epoxy-based system that will react to the common epoxy component.

Besides fibres and resin, composite materials may comprise one or more of fillers (e.g. an inert material) and/or solvents and/or diluents and/or rheological agents and/or viscosity adjusting agents.

The method according to the invention may be adapted to automated processing. For example a robot may advantageously distribute layers comprising fibres, resin, means for oxidizing the surface, organo silane anchoring agent, and optionally adhesive or paint.

Fibre-containing composite materials and chemical compounds used according to the invention may contain components, which may be irritant or harmful when in contact with naked skin, if ingested or inhaled. Since the processes according to the invention are particularly suited for automation and since avoidance of direct contact is therefore highly desirable, the products and processes according to the present invention represent a significant improvement to the working environment.

### Definitions

As used herein a “fibre-containing composite material” refers to a composite material comprising fibres together with a resin or plastic, such as epoxy, polyester or vinylester resin. The term is used interchangeably with the term “fibre reinforced composite material”. The term includes but is not limited to glass-reinforced plastic as well as other composite materials such as carbon-fibre reinforced plastic.

The terms “organo silane anchoring agent” or just “organo silane” as used herein refers to any organic compound comprising a silicon atom containing one to three hydrolyzable groups, such as halogen (bromine, chlorine, fluorine or iodine) or alkoxy groups having one to six carbon atoms, and containing at least one organic group attached directly to the silicon atom. In some preferred embodiments this organic group attached directly to the silicon atom contain one, two, or three free amino groups that may function as anchoring groups with a paint or adhesive coating according to the present invention.

### Specific Embodiments of the Invention

Without being bound to any particular theory, it is thought that the methods according to the present invention will provide/create increased amounts of surface functional groups on the polymeric surface being joined with another surface and will tend to cross link with the adhesives and further to composites to get better adhesion strength in terms of physical and covalent chemical bonding between the anchor molecule-adhesives-polymer substrates.

In general, a polymer based composite surface is difficult to wet due to low surface energy. This may lead to poor adhesion with the adhesive and in laminates. Methods according to the present invention change such behaviour to get good binding strength of polymer composite surface with the adhesives. The present method/innovation is one of the surface activation methods which will lead to high surface energy and which will tend to wet the surface in terms of creating surface functional groups prior to the joining of the two surfaces.

In some embodiments the oxidizing in the methods of the invention is performed by a method selected from corona discharge, flame treatment, plasma treatment, UV radiation, and ozone plasma gas treatment.

In some embodiments the oxidizing in the methods of the invention is by flame treatment.

In some embodiments the anchoring agent used in the methods of the invention is an organo silane selected from the group consisting of an organo silane having 1 to 3 readily hydrolyzable groups and containing at least one organic group attached directly to the silicon atom, the corresponding silanes, silanols and/or polysiloxanes.

In some embodiments the anchoring agent used in the methods of the invention is an organo silane anchoring agent selected from the group consisting of (3-aminopropyl)trimethoxysilane, N-(2-aminoethyl)-3-amino-propyltrimethoxy silane, and 3-amino-propyltriethoxysilane, and aminoethyl-aminopropyl-silanetriol homopolymers.

In some embodiments the anchoring agent used in the methods of the invention is an amine, such as polyamines, such as secondary amines, such as secondary polyamines, such as a polyethyleneimine.

In some embodiments the anchoring agent used in the methods of the invention is a secondary amine selected from the group consisting of: a C2-C36 linear or branched or cyclic compound containing two or more amine groups; and a polymer based amine.

Suitable amines to be used according to the present invention are described in e.g. U.S. Pat. No. 5,922,161. Accordingly a suitable amine to be used according to the methods of the present invention may be selected from the list consisting of: C2 to C36 linear, branched or cyclic compounds containing two or more amine groups; polymers of a number average molecular weight of from 300 to 3 million containing a multiplicity of amine groups; C2 to C36 perfluoroamines; C2 to C36 amino alcohols/phenols; C2 to C36 amino acids; C2 to C36 amino aldehydes/ketones; C2 to C36 amino amides; C2 to C36 amino ethers; C2 to C36 amino esters; C2 to C36 amino nitros; C2 to C36 amino nitriles; C2 to C36 amino thiols; C2 to C36 amino phosphoric acids; and C2 to C36 amino sulfonic acids; C2 to C36 amino halogens; C2 to C36 amino alkenes; C2 to C36 amino alkynes; polymers of a number average molecular weight of from 300 to 3 million containing a multiplicity of amine groups and non-amine functional groups; and amino polysaccharides.

In some embodiments the anchoring agent used in the methods of the invention is selected from the list consisting of a polyethyleneimine, a polyallyl amine, and a polyvinyl amine.

In some embodiments the anchoring agent used in the methods of the invention is a polyethyleneimine with a molecular weight in the range of about 1000 to about 100000 Dalton, such as in the range of about 2000 to about 50000 Dalton, such as in the range of about 2000 to about 40000 Dalton, such as in the range of about 2000 to about 30000 Dalton, such as in the range of about 2000 to about 25000 Dalton, such as about 2000 or about 50000 Dalton.

In some embodiments the oxidizing step in the methods of the invention is by flame treatment with a treatment speed of at least about 40 meters per minute, such as at least about 50 meters per minute, such as at least about 60 meters per minute, such as at least about 70 meters per minute, such as in the range of 40-100 meters per minute, such as in the range of 50-100 meters per minute, such as in the range of 60-100 meters per minute, such as in the range of 60-90 meters per minute.

In some embodiments the oxidizing step is by flame treatment with an air flow rate of less than about 500 L/min, such as less than about 400 L/min, such as less than about 300 L/min, such as less than about 250 L/min, such as less than about 240 L/min, such as in the range of 200 L/min to 250 L/min, such as in the range of 210 L/min to 250 L/min, such as in the range of 220 L/min to 240 L/min.

In some embodiments the oxidizing step is by flame treatment, wherein the flame is derived from combustion of a gas mixture, such as atmospheric air gas mixture, wherein there is an O₂ excess in the flame of at least about 0.8%, such as at least about 1.0%, such as at least about 1.2%, such as at least about 1.4%, such as in the range of 0.8% to about 1.4%, such as in the range of 1.0% to about 1.2%, such as in the range of 1.4% to about 3.6%.

In some embodiments the oxidizing step in the method of the invention is by flame treatment, wherein each fibre-containing composite material is treated by flame treatment once.

In some embodiments the organo silane anchoring agent used in the method of the invention is used in aqueous solution, wherein the organo silane anchoring agent is sprayed in an amount up to 0.5%, such up to 0.4%, such as up to 0.3%, such as up to 0.15%, such as in the range of 0.1% to 0.15% at a speed of 30-75 m/min to make uniform wet film on the bonding surface of GRP material.

In some embodiments the adhesive used in the methods of the invention is selected from polyurethane, epoxy and methacrylate.

In some embodiments one, two, or three of the steps a), b), and c) in the method of the invention is performed with robotic means.

In some embodiments the first and second fibre-containing composite material being joined by the methods according to the present invention are essentially of the same material. In other embodiments the first and second fibre-containing composite material being joined by the methods according to the present invention are of different material.

In some embodiments the joint obtained by the methods of the invention is in a manufactured article, such as a transportation vehicle, for example an aeroplane, spacecraft or an automobile, in a marine craft or train, in a wind turbine blade and the like, such as in a sectioned/partitioned modular blade, in a laminate or in a nacelle covering, in an aerospace component, in a building component, in an infrastructure article such as a bridge, a sewer pipe, telecommunication installation, or other constructions.

In some embodiments the joint obtained by the methods of the invention is in a wind turbine blade, such as in sectioned/partitioned modular blades, in a laminate or in a nacelle cover.

In some embodiments the shear strength of the joint obtained by the methods of the invention is higher than about 10 MPa, such as higher than about 12 MPa, such as higher than about 14 MPa as measured by single lap shear tests using universal tensile test equipment.

The method according to the invention may further comprise a step prior to said step b) of hydrolyzing said anchoring agent in a mild acidic aqueous solution, such as one having a pH lower than 6.0, such as one having a pH lower than 5.5, such as one having a pH lower than 4.0, such as one having a pH lower than 3.5, such as one having a pH lower than 3.2.

Accordingly in some embodiments the anchoring agent may be hydrolyzed prior to the binding to the composite surface. It is to be understood that the hydrolyzing of the organo silane anchoring agent and the subsequent coating may be performed in the same step. Accordingly, the organo silane anchoring agent may be present and used directly in the coating in an acidic aqueous solution, such as one having a pH lower than 6.0, such as one having a pH lower than 5.5, such as one having a pH lower than 4.0, such as one having a pH lower than 3.5, such as one having a pH lower than 3.2. In such an acidic aqueous solution there will be an equilibrium between hydrolyzed compound and non-hydrolyzed with the majority of entities being hydrolyzed. Alternatively the organo silane anchoring agent may be added to the acidic aqueous solution having a pH lower than 6.0, such as one having a pH lower than 5.5, such as one having a pH lower than 4.0, such as one having a pH lower than 3.5, such as one having a pH lower than 3.2, just prior to the coating.

In some embodiments the acidic aqueous solution has a pH lower than 6.0, such lower than 5.5, such as lower than 4.5, such as lower than 4.0, such lower than 3.5, such as lower than 3.2, such as lower than 3.0, such as lower than 2.8, such as lower than 2.6, such as lower than 2.4, such as lower than 2.2, such as lower than 2.0, such as lower than 1.8, such as in the range of 1.8 to 3.2, such as in the range of 1.8 to 3.0, such as in the range of 1.8 to 2.8, such as in the range of 1.8 to 2.6, such as in the range of 1.8 to 2.4, such as in the range of 1.8 to 2.2.

In some embodiments the acidic aqueous solution is a solution of an acid selected from acetic acid, formic acid, oxalic acid, nitric acid, sulphuric acid, and hydrochloric acid.

In some embodiments the acidic aqueous solution is a solution of hydrochloric acid.

In some embodiments the acidic aqueous solution is applied to the glass-containing surface in combination with an organo silane glass fibre anchoring agent.

In some embodiments the acidic aqueous solution is applied to said surface of a fibre-containing composite material by spraying.

In some embodiments the organo silane anchoring agent has 3 readily hydrolyzable groups, such as identical hydrolyzable groups.

In some embodiments the organo silane anchoring agent is an aminosilane represented by the formula

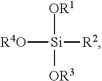

wherein R¹, R³ and R⁴ is a hydrocarbon group and R² is an amino-substituted alkyl radical wherein the alkyl groups have from 1 to 6 carbon atoms.

It is to be understood that R¹, R³ and R⁴ are hydrocarbon groups that may or may not be the identical groups. In a preferred embodiment, two or three of the groups are identical.

In some embodiments the organo silane anchoring agent is an aminosilane represented by the formula

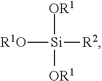

wherein R¹ is a hydrocarbon group and R² is an amino-substituted alkyl radical wherein the alkyl groups have from 1 to 6 carbon atoms.

In some embodiments R² is an amino-substituted alkyl radical with one amino group. In some embodiments R² is an amino-substituted alkyl radical with two amino groups. In some embodiments R² is an amino-substituted alkyl radical with three amino groups.

In some embodiments the surface of a fibre-containing composite material is a glass fibre reinforced plastic surface.

In some embodiments the surface of a fibre-containing composite material is a carbon fibre reinforced plastic surface.

In some embodiments the fibre-containing composite material is a thermo-setting polymer composite. In more specific embodiments the composite is based on a polymer selected from epoxy, polyurethanes, polyimide, polyester, vinyl ester and acrylic.

It is to be understood that the use of a thermo-setting polymer composite may provide the increased strength and/or increased creep resistance and/or increased durability as compared to other polymeric materials. This may be advantageously used for structural applications, such as for use in the joining of wind turbine blades, which may require a thermo-setting composite material instead of thermoplastic ones, which are likely to exhibit sagging and other types of mechanical distortion of blade components (spar bars, cladding skin, etc) due to excessive creep at elevated service temperatures.

In some embodiments the fibre-containing composite material is an epoxy/glass fibre composite material.

In some embodiments the fibre-containing composite material is an epoxy/carbon fibre composite material.

In some embodiments the method further comprises a step prior to said step a) of subjecting said surface of a fibre-containing composite material to a plasma gas treatment and/or flame treatment in order to etch the surface and/or to increase the amount of functional groups, such as hydroxyl, carbonyl, or carboxyl groups on said surface.

In some embodiments the organo silane anchoring agent is used in aqueous solution, wherein the organo silane anchoring agent is present in an amount up to 0.5%, such up to 0.4%, such as up to 0.3%, such as up to 0.15%, such as in the range of 0.1% to 0.15%.

In some embodiments the coating provides a functional layer on the surface of said fibre-containing composite material with a thickness of 10-30 nm.

In some embodiments at least two objects made of fibre reinforced composite material according to the present invention and further coated with an adhesive are bound together on the surface of the coatings.

In some embodiments the adhesive is a polyurethane adhesive.

In some embodiments the object made of glass fibre reinforced composite material is a wind turbine blade.

In some embodiments the laminate or interconnected object prepared according to the present invention has a binding strength between laminate or interconnected objects higher than 10 MPa, such as higher than 12, such as higher than 14 MPa, such as higher than 16 MPa, such as higher than 18 MPa, such as higher than 20 MPa, as measured by single lap shear tests using universal tensile test equipment.

### Example 1

### Preparation of Activated 3-aminopropyl trimethoxysilane or N-(2-aminoethyl)-3-amino-propyltrimethoxy silane

Commerically available amino silane (3-aminopropyl trimethoxysilane or N-(2-aminoethyl)-3-amino-propyltrimethoxy silane) was diluted to 0.25% and mixed properly and stored in room temperature. After 15-20 minutes, the solution was ready for spray for the surface activation of an epoxy/glass fibre reinforced plastic surface.

Alternative anchoring molecules are also prepared by diluting with water into 0.25%. Examples of suitable anchoring molecules includes (a) Aminoethylaminopropyl silane triol homopolymer, (b) polyethylene imine G35 (PEI) (MW=2000), and (c) polyethylene imine WF (PEI) (MW=25000).

Composite surface were cleaned with isopropanol unless other wised stated specifically for specimens in the following table 1, table 2 and table 3.

### Example 2

Two surfaces of an epoxy/glass fibre composite material of a wind turbine blade was activated by robotic means with flame activation with a combustive gas mixture comprising atmospheric air with added O₂ to be in excess of 1.0˜1.2% with a treatment speed of 60-80 meters per minute and an air flow rate of 220-240 Litres per minute in one pass. The distance from the tool to the treated surface was maintained within 10-100 mm. The following conditions were observed: room air temperature 20 degrees Celcius, humidity: 50-100%.

Hereafter the two surfaces were sprayed until the entire surface appears wet with an anchoring molecule solution prepared according to example 1 and 0.5 to 3 mm thick glueline of a polyurethane adhesive was applied to the surfaces and the surfaces were clamped with uniform pressure, to make fast cure, the bond-line will be snap cured with heat or UV exposure etc.

### Example 3

### Analysis of SAT Results

As may be seen from table 1 SAT improves adhesion strength by 40 to 80%.

Test method ASTM D3163 & 5868; Specimen size 25.75 mm; Overlap 12.5 mm; Adhesive thickness 0.5 mm; F1 represent an experiment with a single pass; F2 represent an experiment with two passes; Z-6020 is N-(β-aminoethyl)-γ-aminopropyltrimethoxysilane; G35 is Lupasol® G35 (Polyethylenimine with MW 2000)

TABLE 1

| | Surface “#1” |
|---|---|
| Sample treatment | In-mould |
| Unwashed VESTAS coupons (reference) | 8.48 ± 0.54 |

Flame only

| | |
|---|---|
| F1 40 m/min | 10.02 ± 1.10* |
| F2 40 m/min | 7.75 ± 0.43* |
| F1 60 m/min | 11.85 ± 2.06* |
| F2 60 m/min | 10.94 ± 0.99* |
| F1, 80 m/min | 12.87 ± 2.27^{#} |
| F2, 80 m/min | 11.54 ± 1.83^{#} |
| F1 95 m/min | 12.33 ± 1.43* |
| F2 95 m/min | 12.37 ± 1.20* |

SAT (Flame + graft chemicals)

| | |
|---|---|
| F1 60 m/min + 0.25% Z6020 | 17.66 ± 1.06^{#} |
| F1 60 m/min + 0.25% Z6020 | 18.89 ± 3.19^{#} |
| F2 60 m/min + 0.25% Z6020 | 14.52 ± 2.24^{#} |
| F1 60 m/min + 0.25% Z6137 | 14.86 ± 1.63^{#} |
| F1 60 m/min + 0.25% G35 | 14.18 ± 3.29* |
| F2 60 m/min + 0.25% G35 | 13.91 ± 2.14* |
| F1 60 m/min + 0.25% WF | 13.33 ± 2.20* |
| F2 60 m/min + 0.25% WF | 13.73 ± 0.97* |
| F1 80 m/min + 0.25% Z6020 | 14.77 ± 1.09^{#} |
| F2 80 m/min + 0.25% Z6020 | 13.59 ± 0.63^{#} |
| F1 95 m/min + 0.25% G35 | 15.15 ± 0.54* |
| F2 95 m/min + 0.25% G35 | 14.78 ± 0.37* |
| F1 95 m/min + 0.25% Z6020 | 14.67 ± 0.51* |
| F2 95 m/min + 0.25% Z6020 | 15.13 ± 0.54* |

Table 2 show the influence of oxygen excess (O₂) on the strength of bond. Flame treatment speed: 60 m/min. Test rate: 1.3 mm/min. Air flow rate (nominal): 240 litres/min.

TABLE 2

| O₂ excess in flame | Flame + Z 6020 | Flame + G 35 |
|---|---|---|
| 0.4% | 10.4 ± 1.4 | — |
| 0.8% | 11.4 ± 1.5 | — |
| 1.0% | 11.0 ± 3.0 | 12.2 ± 2.2 |
| 1.2% | 16.9 ± 2.0 | 19.8 ± 1.7 |
| 1.4% | 9.9 ± 1.8 | 14.0 ± 1.4 |

Table 3 show the influence of flow rate of combustive mixture (air+oxygen) on effectiveness of SAT treatment (flame treatment speed: 60 m/min; test rate: 1.3 mm/min.

TABLE 3

| Fuel flow rate | | |
|---|---|---|
| [l/min] | 400 l/min, 2 passes | 240 l/min, 1 pass |
| Flame only | 5.9 ± 0.6 | — |
| Flame + Z6020 | 13.2 ± 2.2 | 16.0 ± 1.6 |
| Flame + G35 | — | 18.3 ± 1.2 |

1. A method for preparing a joint of a first fibre-containing composite material and a second fibre-containing composite material the method comprising the sequential steps of:
a) oxidizing the surfaces of said first and second fibre-containing composite material in order to etch the surface and/or to increase the amount of functional groups, such as hydroxyl groups on said surfaces;
b) coating said surfaces of said first and second fibre-containing composite material with at least one anchoring agent selected from an organo silane or an amine;
c) applying an adhesive to said surfaces; and
d) combining said first and second fibre-containing composite material in a joint.

2. The method according to claim 1, wherein said oxidizing is performed be a method selected from corona discharge, flame treatment, plasma treatment, UV radiation, and ozone plasma gas treatment.

3. The method according to claim 2, wherein said oxidizing is by flame treatment.

4. The method according to claim 1, wherein said anchoring agent is an organo silane selected from the group consisting of an organo silane having 1 to 3 readily hydrolyzable groups and containing at least one organic group attached directly to the silicon atom, the corresponding silanes, silanols and/or polysiloxanes.

5. The method according to claim 4, wherein said organo silane anchoring agent is an aminosilane represented by the formula 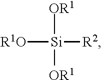
wherein R¹ is a hydrocarbon group and R² is an amino-substituted alkyl radical wherein the alkyl groups have from 1 to 6 carbon atoms.

6. The method according to claim 4, wherein said organo silane anchoring agent is selected from the group consisting of (3-aminopropyl)trimethoxysilane, N-(2-aminoethyl)-3-amino-propyltrimethoxy silane, and 3-amino-propyltriethoxysilane, and aminoethyl-aminopropyl-silanetriol homopolymers.

7. The method according to claim 1, wherein said anchoring agent is an amine, such as secondary amines, such as a polyethyleneimine.

8. The method according to claim 7, wherein said anchoring agent is a secondary amine selected from the group consisting of: a C2-C36 linear or branched or cyclic compound containing two or more amine groups; and a polymer based amine.

9. The method according to claim 7, wherein said anchoring agent is selected from the group consisting of a polyethyleneimine, a polyallyl amine and a polyvinyl amine.

10. The method according to claim 7, wherein said anchoring agent is a polyethyleneimine with a molecular weight in the range of about 1000 to about 100000 Dalton, such as in the range of about 2000 to about 50000 Dalton, such as in the range of about 2000 to about 40000 Dalton, such as in the range of about 2000 to about 30000 Dalton, such as in the range of about 2000 to about 25000 Dalton, such as about 2000 or about 50000 Dalton.

11. The method according to claim 1, wherein the said oxidizing is by flame treatment with a treatment speed of at least about 40 meters per minute, such as at least about 50 meters per minute, such as at least about 60 meters per minute, such as at least about 70 meters per minute, such as in the range of 40-100 meters per minute, such as in the range of 50-100 meters per minute, such as in the range of 60-100 meters per minute, such as in the range of 60-90 meters per minute.

12. The method according to claim 1, wherein the said oxidizing is by flame treatment with an air flow rate of less than about 500 L/min, such as less than about 400 L/min, such as less than about 300 L/min, such as less than about 250 L/min, such as less than about 240 L/min, such as in the range of 200 L/min to 250 L/min, such as in the range of 210 L/min to 250 L/min, such as in the range of 220 L/min to 240 L/min.

13. The method according to claim 1, wherein the said oxidizing is by flame treatment, wherein the flame is derived from combustion of a gas mixture, such as atmospheric air gas mixture, wherein is O₂ excess in flame of at least about 0.8%, such as at least about 1.0%, such as at least about 1.2%, such as at least about 1.4%, such as in the range of 0.8% to about 1.4%, such as in the range of 1.0% to about 1.2%, such as in the range of 1.4% to about 3.6%.

14. The method according to claim 1, wherein the said oxidizing is by flame treatment, wherein each fibre-containing composite material is treated by flame treatment once.

15. The method according to claim 1, wherein said organo silane anchoring agent is used in aqueous solution, wherein the organo silane anchoring agent is sprayed in an amount up to 0.5%, such up to 0.4%, such as up to 0.3%, such as up to 0.15%, such as in the range of 0.1% to 0.15% at a speed of 30-75 m/min to make uniform wet on the bonding surface of GRP material.

16. The method according to claim 1, wherein the said adhesive is selected from polyurethane, epoxy and methacrylate.

17. The method according to claim 1, wherein said fibre-containing composite material is a thermo-setting polymer composite.

18. The method according to claim 17, wherein said composite is based on a polymer selected from epoxy, polyurethanes, polyimide, polyester, vinyl ester and acrylic.

19. The method according to claim 1, wherein said fibre-containing composite material is a glass fibre reinforced plastic.

20. The method according to claim 1, wherein said fibre-containing composite material is an epoxy/glass fibre composite material.

21. The method according to claim 1, wherein one, two, or three of said method steps a), b) and c) is performed with robotic means.

22. The method according to claim 1, wherein said first and second fibre-containing composite material are essentially of the same material.

23. The method according to claim 1, wherein said joint is in a manufactured article, such as a transportation vehicle, for example an aeroplane, spacecraft or an automobile, in a marine craft or train, sin a wind turbine blade and the like, such as in a sectioned/partitioned modular blade, in a laminate or in a nacelle covering, in an aerospace component, in a building component, in an infrastructure article such as a bridge, a sewer pipe, telecommunication installation, or other constructions.

24. The method according to claim 23, wherein said joint is in a wind turbine blade, such as in sectioned/partitioned modular blades, in a laminate or in a nacelle cover.

25. The method according to claim 1, wherein the shear strength of said joint is higher than about 10 MPa, such as higher than about 12 MPa, such as higher than about 14 MPa as measured by single lap shear tests using universal tensile test equipment.

26. The method according to claim 1, wherein the method further comprises a step prior to said step b) of hydrolyzing said anchoring agent in an acidic aqueous solution having a pH lower than 6.0.

27. The method according to claim 26, wherein said acidic aqueous solution has a pH lower than 5.5, such as lower than 4.5, such as lower than 4.0, such lower than 3.5, such as lower than 3.2, such as lower than 3.0, such as lower than 2.8, such as lower than 2.6, such as lower than 2.4, such as lower than 2.2, such as lower than 2.0, such as lower than 1.8, such as in the range of 1.8 to 3.2, such as in the range of 1.8 to 3.0, such as in the range of 1.8 to 2.8, such as in the range of 1.8 to 2.6, such as in the range of 1.8 to 2.4, such as in the range of 1.8 to 2.2.

28. The method according to claim 26, wherein said acidic aqueous solution is a solution of an acid selected from acetic acid, formic acid, oxalic acid, nitric acid, sulphuric acid, and hydrochloric acid.

29. Fibre reinforced composite material comprising a joint prepared by a method according to claim 1.

30. Laminate or interconnected object of fibre reinforced composite material produced by a method according to claim 1.

31. Wind turbine blade made by a process according to claim 1, or made of a laminate or interconnected objects according to claim 30.

32. Wind turbine comprising one or more wind turbine blades according to claim 31.

33. A method for improving interfacial strength of a joint of two objects made of fibre-containing composite material, said method comprising the sequential steps of:
a) oxidizing the surfaces of said first and second fibre-containing composite material in order to etch the surface and/or to increase the amount of functional groups, such as hydroxyl groups on said surfaces;
b) coating said surfaces of said first and second fibre-containing composite material with at least one anchoring agent selected from an organo silane or an amine;
c) applying an adhesive to said surfaces; and
d) combining said first and second fibre-containing composite material in a joint.

34. (canceled)

35. A robot suitable for carrying the method according to claim 1.

36. Use of a chemical composition comprising organo silane selected from the group consisting of an organo silane having 1 to 3 readily hydrolyzable groups and containing at least one organic group attached directly to the silicon atom, the corresponding silanes, silanols and/or polysiloxanes, for establishing anchoring for an adhesive on a fibre-containing material.

37. A tool for a robot, the tool including a first tool side pointing in a forward direction and a second tool side pointing in an opposite rearward direction, the first tool side comprising at least one spray nozzle in fluid communication with a high pressure spray system for spraying an anchoring agent, and the second tool side comprising a nozzle for establishing an O₂ enriched flame.

38. A tool according to claim 37, the tool further comprising an attachment surface for assembly with a robot against a tool attachment surface, the attachment surface facing in a direction being transverse to the forward and to the rearward directions.
